(19) United States
(12) Patent Application Publication
(10) Pub. No.: US 2026/0287026 A1
(43) Pub. Date: Sep. 24, 2026

(54) DOUBLE CLUTCH ARRANGEMENT, DRIVE TRAIN AND WORK MACHINE

(71) Applicant: DEERE & COMPANY, MOLINE, IL (US)

(72) Inventors: MATTHIAS LANG, Mannheim (DE); DAVID MUELLER, Dettenheim (DE); STEFAN RAISCH, Vaihingen an der Enz (DE)

(21) Appl. No.: 19/422,735

(22) Filed: Dec. 17, 2025

(30) Foreign Application Priority Data
Mar. 19, 2025 (EP) 25164610.5
Mar. 19, 2025 (EP) 25164611.3

(51) Int. Cl. F16D 13/38; F16D 13/52; F16D 13/58

(52) U.S. Cl. CPC F16D 13/385; F16D 13/52; F16D 13/58

(57) ABSTRACT

The disclosure relates to a double clutch arrangement, for example, a double clutch, for arranging in a drive train of a work machine or in a work machine. The double clutch arrangement comprises a first clutch cover, which is rotatable about an axis of rotation of a first and a second output sides, and a second clutch cover, which is rotatable about the axis of rotation of the first and second output sides. The first output side is mounted on the first clutch cover and the second output side is mounted on the second clutch cover. The disclosure further relates to a drive train and to a work machine.

### CROSS-REFERENCE TO RELATED APPLICATIONS

This application claims priority to European Patent Application Nos. 25164610.5 and 25164611.3, each filed on Mar. 19, 2025, and which are hereby incorporated by reference.

### TECHNICAL FIELD

The disclosure relates to a double clutch arrangement, a drive train, and a work machine.

### BACKGROUND

Double clutch arrangements for arranging between a drive unit and a transmission are known in practice. The known double clutch devices are composed of a first clutch pack, which is assigned to a first output side, and in particular to a first driven shaft, for optional transmission of torque between the drive unit and the first output side, and in particular the first driven shaft, and of a second clutch pack, which is assigned to a second output side, and in particular to a second driven shaft, for optional transmission of torque between the drive unit and the second output side, and in particular the second driven shaft. The first driven shaft can be assigned to the first output side and the second driven shaft can be assigned to the second output side. Furthermore, in particular, double clutch arrangements, in which the associated clutch packs have a common input side assigned to the drive unit, are known from practice.

### SUMMARY

It is an object of the present disclosure to propose a double clutch arrangement and a drive train and a work machine which are improved. More specifically, it is an object of the present disclosure to propose a double clutch arrangement and a drive train and a work machine which are structurally simpler and/or compact configuration.

This object is achieved by a double clutch arrangement having the features of one or more embodiments disclosed herein, and a drive train having the features of one or more embodiments disclosed herein, and a work machine having the features of one or more embodiments disclosed herein.

“Connected” can be understood below as preferably mechanically connected and/or mechanically operatively connected and/or connected for conjoint rotation. In particular, “connected” can be understood, additionally or alternatively, as drivably connected, that is, torque-transmittingly and/or rotational speed-transmittingly connected, and/or coupled, that is, in particular mechanically coupled and/or rigidly coupled, and/or coupled for conjoint rotation. “Connectable” can preferably be understood as mechanically connectable and/or mechanically operatively connectable and/or connectable for conjoint rotation. In particular, “connectable” can be understood, additionally or alternatively, as drivably connectable, that is, torque-transmittingly and/or rotational speed-transmittingly connectable, and/or couplable, that is, mechanically couplable and/or rigidly couplable, and/or connectable for conjoint rotation. “Connected” can therefore in particular be understood as a connection of two components which makes it possible to transmit energy and/or force and/or a torque and/or a rotational speed from one component to the other, in particular mechanically. Further components or parts enabling such a transmission of energy and/or force and/or torque and/or transmission of a rotational speed between the two components can be provided between the two components.

According to the disclosure, a double clutch arrangement, in particular a double clutch, for arranging in a drive train of a work machine, in particular between a drive unit and a transmission, or a work machine, is proposed. The double clutch arrangement comprises a first clutch cover, which is rotatable about an axis of rotation A of a first and second output side of the double clutch arrangement, in particular first clutch basket, and a second clutch cover, which is rotatable about the axis of rotation A of the first and second output side, in particular second clutch basket. The first output side is mounted in and/or on the first clutch cover and the second output side is mounted in and/or on the second clutch cover.

The first and the second output side can be in the form of a first and second output hub or first and second hub. The first and second output side, in particular the first and second output hub or the first and second hub, can be formed in a tubular manner with a radially outwardly facing support surface. The first and the second output side can be rotatable about the axis of rotation. The axis of rotation can be designed in particular as a common axis of rotation.

The first and second clutch cover, in particular the first and second clutch basket, can be connectable or connected, in particular connectable for conjoint rotation or connected for conjoint rotation. The first and second clutch cover, in particular the first and second clutch basket, in particular when they are connected to each other, can form a clutch housing. The first and second clutch cover, in particular when they are connected to each other, can form one or more cavities. The clutch housing, in particular when the first and second clutch cover are connected to each other, can form the one or more cavities. The first and second output side, in particular the first and second hub, can be arranged in the cavity or the cavities. The first and second output side, in particular the first and second hub, can be arranged within the first and second clutch cover. The first and second clutch cover, in particular the clutch housing, can be rotatable about the axis of rotation, in particular the common axis of rotation.

The double clutch arrangement can have an input side, in particular a common input side. The first clutch cover can, in particular at least partially, comprise the input side, in particular the common input side. The first clutch cover can, in particular at least partially, be designed as the input side, in particular as the common input side, and/or comprise the input side. The input side can be in the form of an input hub or third hub. The input side, in particular the input hub or the third hub, can be formed in a tubular manner with a radially outwardly facing support surface. The input side, in particular the input hub or the third hub, can be rotatable about the axis of rotation, in particular the common axis of rotation.

Specifically, the first clutch cover can, in particular at least partially, be designed as an input hub or third hub or comprise the input hub or third hub. The input side, in particular the input hub or the third hub, can be formed in a tubular manner in the first clutch cover. The radially outwardly facing support surface can, in particular at least partially, be designed as a clutch basket. The first clutch cover, preferably the input side, particularly preferably the input hub or third hub, can be connectable to the drive unit.

The double clutch arrangement, in particular the double clutch, can comprise a first and second driven shaft. The first and second driven shaft can be connectable to an input side of the transmission. The first driven shaft can be connectable or connected to the first output side and/or the second driven shaft can be connectable or connected to the second output side, in particular can be connectable or connected by splines. In each case a force and/or a torque and/or a rotational speed can be transmissible from the first output side to the first driven shaft and/or from the second output side to the second driven shaft.

The double clutch arrangement, in particular the double clutch, can comprise an input shaft. The input shaft can be connectable to the drive unit. The input shaft can be connectable or connected to the input side, in particular connectable or connected by splines. A force and/or a torque and/or a rotational speed can be transmissible, in particular from the drive unit, to the input side, in particular to the first clutch cover. A force and/or a torque and/or a rotational speed can be transmissible from the input shaft to the input side, in particular to the first clutch cover. A force and/or a torque and/or a rotational speed can be transmissible from the drive unit to the input shaft and/or the input side, in particular to the first clutch cover.

The first and/or second output side and/or the input side can each have one or more shaft feedthroughs and/or one or more central passages for the input shaft. The input shaft can at the same time be designed as a power take-off drive shaft (PTO drive shaft), that is to say in particular can drive a PTO unit. The input shaft, in particular the power take-off drive shaft, can be arranged in the first output side and the input side. The input shaft, in particular the power take-off drive shaft, can be embodied as a solid shaft. The first and second driven shaft can be in the form of hollow shafts. The first driven shaft can be arranged and/or mounted in the second driven shaft, in particular can be freely rotatably arranged and/or mounted. The first and second driven shaft can be arranged and/or mounted coaxially with each other and/or one in the other, in particular freely rotatably one in the other. The first driven shaft can extend, preferably concentrically, through the second driven shaft. The input shaft, in particular the power take-off drive shaft, can be arranged and/or mounted in the first driven shaft, in particular can be freely rotatably arranged and/or mounted. The input shaft, in particular the power take-off drive shaft, and the first driven shaft can be arranged and/or mounted coaxially with each other and/or one in the other, in particular can be freely rotatably arranged and/or mounted one in the other. The input shaft can extend, preferably concentrically, through the first driven shaft. In this way, a direct and therefore particularly energy-efficient transmission of the driving power from the drive unit to a PTO unit is possible. In addition, the double clutch arrangement can be of very compact configuration.

The first and/or the second clutch cover can have a sensor target, in particular an encapsulated sensor target, for determining the rotational speed during operation. The sensor target can be configured in such a way that one or more flanks of the one or more teeth are designed as part of the first and/or the second clutch cover. The sensor target can be configured in such a way that one or more flanks of the one or more teeth are formed in the casting of the first and/or the second clutch cover. This permits a small distance from the sensor.

The first and second output side may be mounted within the two clutch halves. As a result, the double clutch arrangement can be mounted in a particularly simple manner and as a cohesive module, in particular on the transmission. Moreover, the mounting of the first and second output sides and/or of the first and second driven shafts can thereby be simplified and/or structurally configured.

In a refinement of the disclosure, the first output side is mounted on the first clutch cover with a first bearing and the second output side is mounted on the second clutch cover with a second bearing. The first and second bearing can be in the form of ball bearings, rolling bearings or hydrodynamic plain bearings. In the case of a hydrodynamic plain bearing, the lubricant of the lubricating oil path or pressure oil path can be used.

In a refinement of the disclosure, the double clutch arrangement comprises a first and second clutch pack. The first clutch pack can, in particular at least partially, be arranged in and/or on the first clutch basket. The second clutch pack can, in particular at least partially, be arranged in and/or on the second clutch basket. The first and second clutch pack can be arranged in the clutch housing. The first and second clutch pack can be surrounded by the first and second clutch cover, or in particular by the clutch housing. The first and second clutch pack can be formed and/or arranged radially symmetrically. The double clutch arrangement has the advantages mentioned above. In addition, the forces acting as a result of the actuation of the clutch packs can be particularly reliably supported.

In a refinement of the disclosure, the first clutch pack is configured in such a way that it connects the first clutch cover, in particular the first clutch basket, to the first output side when the first clutch pack is in engagement, and/or the second clutch pack is configured in such a way that it connects the second clutch cover, in particular the second clutch basket, to the second output side when the second clutch pack is in engagement. The first output side, and in particular the first driven shaft, can be assigned the first clutch pack for optionally transmitting energy and/or force and/or a torque and/or a rotational speed between the input side, and/or in particular the input shaft, and the first output side, and/or in particular the first driven shaft. In other words, energy and/or force and/or a torque and/or a rotational speed can optionally be transmissible from the input side, and/or in particular the input shaft, to the first output side, and/or in particular to the first driven shaft, by the first clutch pack. The first clutch pack can be connectable or connected to the first output side. The second output side, and in particular the second driven shaft, can be assigned the second clutch pack for optionally transmitting energy and/or force and/or a torque and/or a rotational speed between the input side, and/or in particular the input shaft, and the second output side, and/or in particular the second driven shaft. In other words, energy and/or force and/or a torque and/or a rotational speed can optionally be transmissible from the input side, and/or in particular the input shaft, to the second output side, and/or in particular to the second driven shaft, by the second clutch pack. The second clutch pack can be connectable or connected to the second output side. The double clutch arrangement has the advantages mentioned above.

In a refinement of the disclosure, the first output side is arranged radially within the first and second clutch cover, in particular within the clutch housing. The first output side can, in particular at least partially, be arranged radially within the second output side. The second output side can be arranged radially within the first and second clutch clover, in particular within the clutch housing. The first output side can be arranged, at least partially, in the second output side in the axial direction or along the axis of rotation A.

In a refinement of the disclosure, the first and/or second output side is/are in the form of a hollow hub and/or in the form of a hollow shaft. In a refinement of the disclosure, the first and second clutch pack are arranged axially. The first and second clutch pack can be axially nested or axially offset. Specifically, the first and second clutch pack can be nested or offset in the direction of or along the axis of rotation. As a result, a compact design and arrangement of the double clutch arrangement can be realized.

In a refinement of the disclosure, the first and/or second clutch pack is/are in the form of a multi-disk clutch arrangement, preferably a wet-running or dry multi-disk clutch arrangement. The multi-disk clutch arrangement can comprise at least one friction disk which is provided with friction linings and is connected to an input or output disk carrier for conjoint rotation. The multi-disk clutch arrangement can comprise at least two plates, which are arranged on the one or on the other side of the at least one friction disk and are connected to the respective other of the input and output disk carrier for conjoint rotation. The first and second clutch cover can each comprise an input disk carrier. Specifically, the first and/or the second clutch cover can each, at least partially, be designed as an input disk carrier. The first and second output side can each comprise an output disk carrier. Specifically, the first and second output side can each, at least partially, be designed as an output disk carrier. Each clutch pack can operate between a disengaged position and an engaged position, in which the plates and the friction disk clamp the friction linings in such a way that energy and/or force and/or a torque and/or a rotational speed can be transmitted between the input disk carrier and an output disk carrier.

In a refinement of the disclosure, the double clutch arrangement comprises a bearing carrier, which is arranged between the first and second clutch cover. The first and second clutch cover and the bearing carrier can be connectable or connected to fastening elements, preferably connectable or connected in an interacting manner, particularly preferably connectable or connected for conjoint rotation and/or secured against each other. A plurality of first bearing elements can be arranged between the first clutch cover and the bearing carrier, and a plurality of second bearing elements, which are in particular different from the first bearing elements, can be arranged between the second clutch cover and the bearing carrier.

The bearing carrier can be annular and/or hollow-cylindrical. The bearing carrier can be arranged between the first and second clutch pack. The bearing carrier and the first and second clutch cover can have cutouts, in particular bores or holes. The bearing carrier and the first and second clutch cover can be connectable or connected to one another, in particular in an interacting manner, by fastening elements arranged in the cutouts, in particular can be connectable or connected to one another for conjoint rotation and/or can be secured against one another. The fastening elements can be screws, for example. The fastening elements can be arranged in the cutouts, in particular bores or holes. In particular, the fastening elements can be inserted through the cutouts, in particular bores or holes. The fastening elements can be connectable or connected to the cutouts using screw threads in the cutouts, and in particular be secured.

In a refinement of the disclosure, the first bearing elements are in each case distributed and/or arranged in the circumferential direction on a first side of the bearing carrier, in particular on a side of the bearing carrier facing the first clutch cover, in particular at uniform distances. The second bearing elements are in each case distributed and/or arranged in the circumferential direction on a second side of the bearing carrier, in particular on a side of the bearing carrier facing the second clutch cover, at uniform distances. The fastening elements can in each case be distributed and/or arranged in the circumferential direction on the first and second clutch cover and the bearing carrier, in particular at uniform distances. The first and second bearing elements, and in particular the fastening elements, can be offset with respect to one another in the circumferential direction. The first and second bearing elements, and in particular the fastening elements, can be offset tangentially with respect to one another, in particular in the circumferential direction. In other words, the first and second clutch cover can be rotated with respect to one another in such a way that the first and second bearing elements do not come to lie centrally and/or symmetrically with respect to one another, but are offset tangentially. The first and second bearing elements, and in particular the fastening elements, can thus be arranged directly next to one another, but not centrally with respect to one another. The first and second bearing elements, and in particular the fastening elements, can be at predefinable distances. The first and second bearing elements, and in particular the fastening elements, can thus operate against a solid part of the opposite clutch cover. Advantageously, as a result, there is sufficient space on one side between the spring packs for connecting the two clutch covers by the fastening elements.

In a refinement of the disclosure, the first bearing elements are in the form of first springs or first spring pairs or first helical compression springs, and the second bearing elements are in the form of second springs or second spring pairs or second helical compression springs. The fastening elements can be in the form of screws.

In a refinement of the disclosure, the fastening elements and/or the first and/or second bearing elements are arranged coaxially and/or concentrically with respect to the axis of rotation A. The fastening elements and/or the first and/or second bearing elements can be spaced apart and/or arranged with the same radius R with respect to the axis of rotation A.

The disclosure furthermore relates to a drive train having the double clutch arrangement.

In a refinement of the disclosure, the drive train comprises a drive unit and a transmission, wherein the drive unit is connectable or connected to the first clutch cover, and/or the first and second output side are, in particular optionally, connectable or connected to the transmission. The drive unit can be, for example, an internal combustion engine or an electric motor. The transmission can be a double clutch transmission, in particular with at least one winding path gear.

The disclosure furthermore relates to a work machine comprising the double clutch arrangement or the drive train.

The work machine can be a construction machine or a towing vehicle, preferably an agricultural towing vehicle, for example a tractor or farm tractor. The work machine has the above-described advantages.

The work machine can comprise the drive unit. The work machine can be drivable with a rotational speed and/or force and/or a torque of a drive unit. The drive unit can be, for example, an internal combustion engine or an electric motor. The work machine can comprise the one or more ground-engaging means. The ground-engaging means can support and/or carry the work machine on the ground. The ground-engaging means can be wheels or tracks or chains. In particular, the ground-engaging means can be front wheels and rear wheels.

Other features and aspects will become apparent by consideration of the detailed description, claims, and accompanying drawings.

### BRIEF DESCRIPTION OF THE DRAWINGS

The disclosure and other advantages and advantageous developments and refinements of the disclosure, both in terms of hardware and in terms of method, will be explained in greater detail below on the basis of example embodiments and with reference to the drawing. Components with an equivalent or comparable function are identified here by the same reference signs.

FIG. 1 shows a schematic illustration of a first example embodiment of a work machine according to the disclosure.

FIG. 2 shows a schematic illustration of the first example embodiment of the double clutch arrangement according to the disclosure.

FIG. 3 shows another schematic illustration of the first example embodiment of the double clutch arrangement according to the disclosure from FIG. 2.

FIG. 4 shows another schematic illustration of the first example embodiment of the double clutch arrangement according to the disclosure from FIG. 2.

FIG. 5 shows a schematic illustration of a second example embodiment of the double clutch arrangement according to the disclosure.

FIG. 6 shows a schematic illustration of a drive train according to the disclosure.

Like reference numerals are used to indicate like elements throughout the several figures.

### DETAILED DESCRIPTION

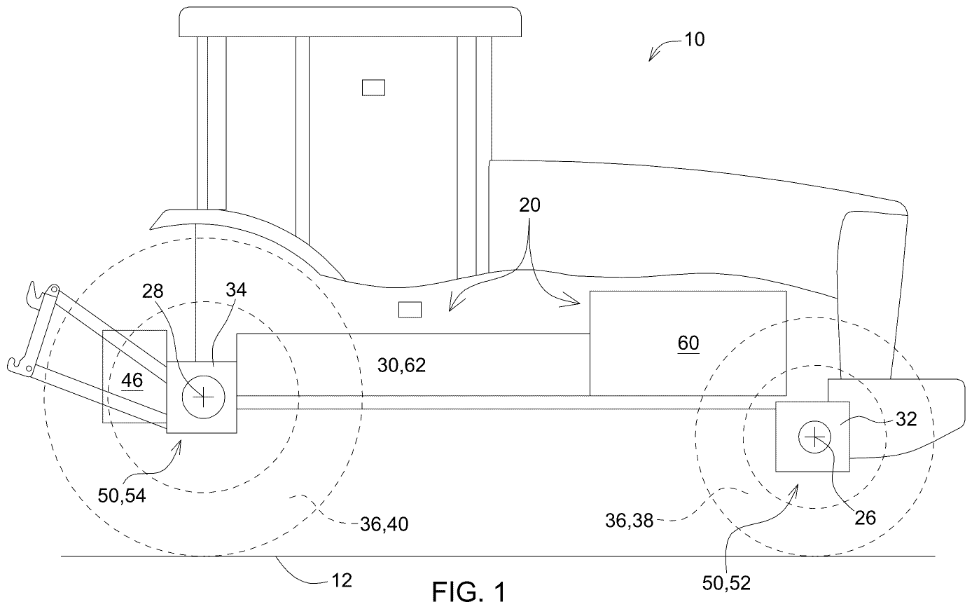

FIG. 1 shows a schematic illustration of a first example embodiment of a work machine 10 according to the disclosure, here of an agricultural towing vehicle or tractor or farm tractor, in particular having a double clutch arrangement 30 according to the disclosure. The work machine 10 comprises a drive train 20 according to the disclosure. In addition, the work machine 10 is drivable by the drive train 20.

The work machine 10, in particular the drive train 20, comprises a first vehicle axle 26 and a second vehicle axle 28. The first vehicle axle 26 can be a front axle, and the second vehicle axle 28 can be a rear axle. Moreover, the first vehicle axle 26 can be embodied as a steerable axle. The work machine 10, in particular the drive device 20, can comprise a traction drive 50, in particular a front-axle drive 52 and a rear-axle drive 54. The work machine 10 can have one or more ground-engaging means 36, in this case illustrated in the form of wheels 38, 40, which engage with an underlying surface 12 in order to transmit drive forces and/or by way of which the work machine 10 is supported on the underlying surface 12. Alternatively, the ground-engaging means 36 can also be configured and arranged as tracks or chains.

The traction drive 50 can comprise the first vehicle axle 26 and/or the second vehicle axle 28 and/or a first differential 32 and/or a second differential 34 and/or the one or more ground-engaging means 36. The first vehicle axle 26 can be connected to the first differential 32. The second vehicle axle 28 can be connected to the second differential 34.

The work machine 10, in particular the drive train 20, comprises a drive unit 60 and a transmission 62. With the drive train 20, in particular the drive unit 60, a rotational movement and/or force and/or a torque and/or a rotational speed can be generatable and can be transmissible, in particular via the transmission 62, to the first and/or second vehicle axle 26, 28. The first and/or second vehicle axle 26, 28 convert the rotational movement and/or force and/or the torque and/or the rotational speed into a rotational movement and/or force and/or torque and/or rotational speed of one or more ground-engaging means 36, and thus into propulsion of the work machine 10.

The work machine 10, in particular the drive train 20, can comprise a first power output 46. The first power output can comprise a PTO unit 206 (see FIG. 6). The first power output 46 can be provided for the purpose of driving an implement (not shown), which can be attached to the work machine 10 via an interface (e.g. three-point interface).

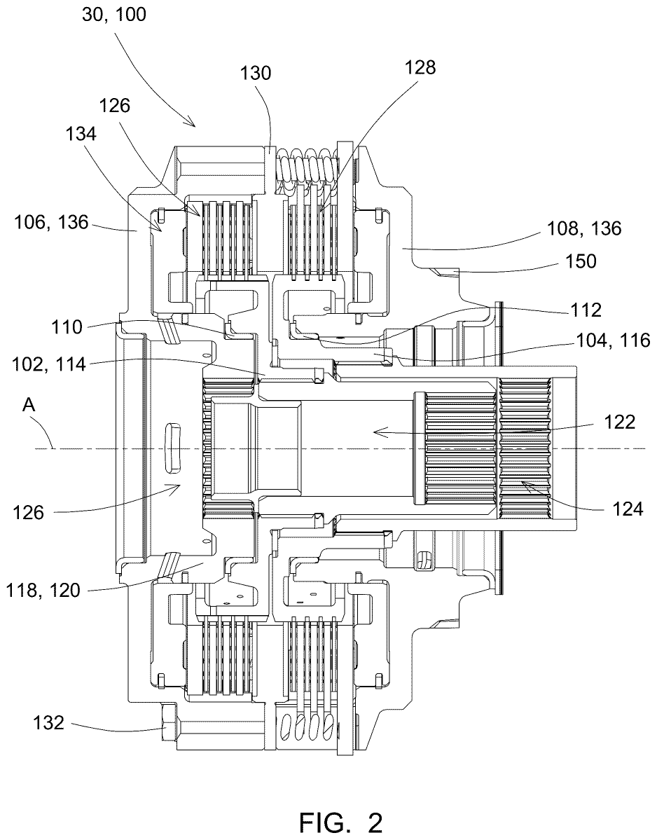

FIG. 2 shows a schematic illustration of a first example embodiment of the double clutch arrangement 30 according to the disclosure. The double clutch arrangement 30 shown in FIG. 2 substantially corresponds to the double clutch arrangement 30 shown in FIG. 1, and therefore only details and/or points of differentiation will be discussed below. The work machine 10 illustrated in FIG. 1 or the drive train 20 can comprise the double clutch arrangement 30 illustrated in FIG. 2.

The double clutch arrangement 30, in particular a double clutch 100, for arranging in a drive train 20 of a work machine 10 or in a work machine 10, comprises a first clutch cover 106, which is rotatable about an axis of rotation A of a first and second output side 102, 104 of the double clutch arrangement, and a second clutch cover 108, which is rotatable about the axis of rotation A of the first and second output side 102, 104. The first output side 102 is mounted on the first clutch cover 106 and the second output side 104 is mounted on the second clutch cover 108. Specifically, the first output side 102 is mounted on the first clutch cover 106 with a first bearing 110 and the second output side 104 is mounted on the second clutch cover 108 with a second bearing 112. The double clutch arrangement 30 can also comprise a bearing carrier 130, which is arranged between the first and second clutch cover 106, 108.

The first and second output side 102, 104 are in the form of a first and second hub 114, 116. The first and second output side 102, 104 are rotatable about the axis of rotation A. The double clutch arrangement 30 moreover has an input side 118, in particular a common input side. The first clutch cover 106 comprises the input side 118, in particular the common input side. The first clutch cover 106 is, in particular at least partially, designed as an input side 118, in particular as a common input side, and comprises the input side 118. The input side 118 is in the form of a third hub 120. The input side 118 or the third hub 120 is rotatable about the axis of rotation A. The first clutch cover 106, preferably the input side 118 or the third hub 120, can be connectable to the drive unit 60.

The double clutch arrangement 30, in particular the double clutch 100, can comprise a first and second driven shaft (not illustrated). The first driven shaft can be connectable or connected to the first output side 102, in particular the first hub 114, and/or the second driven shaft can be connectable or connected to the second output side 104, in particular the second hub 116, in particular can be connectable or connected by splines. The double clutch arrangement 30, in particular the double clutch 100, can comprise the input shaft (not illustrated). The input shaft can be connectable to the drive unit 60. The input shaft can be connectable or connected to the input side 118 or the third hub 120, in particular can be connectable or connected by splines.

The first output side 102 can be arranged radially within the first and second clutch cover 106, 108, in particular within the clutch housing. The first output side 106 can be arranged partially radially within the second output side 108. The second output side 108 can be arranged radially within the first and second clutch cover 106, 108, in particular within the clutch housing. The first and/or the second output side 106, 108 and/or the input side 118 can be in the form of a hollow hub and/or in the form of a hollow shaft. The first and/or second output side 106, 108 and/or the input side 118 can each have a shaft feedthrough 122, 124, 126 and/or in each case a central passage for an input shaft.

The double clutch arrangement 30, in particular the double clutch 100, comprises a first and a second clutch pack 126, 128. The first clutch pack 126 is configured in such a way that it connects the first clutch cover 106 to the first output side 102 when the first clutch pack 126 is in engagement, and/or the second clutch pack 128 is configured in such a way that it connects the second clutch cover 108 to the second output side 104 when the second clutch pack 128 is in engagement.

As a result, if a force and/or a torque and/or a rotational speed is transmitted from the drive unit 60 to the input side 118, in particular to the first clutch cover 106, a force and/or a torque and/or a rotational speed can be transmissible via the first clutch pack 126 to the first output side 102. Alternatively or additionally, if a force and/or a torque and/or a rotational speed is transmitted from the drive unit 60 to the input side 118, in particular to the first clutch cover 106, a force and/or a torque and/or a rotational speed can be transmissible via the second clutch pack 128 to the second output side 104. The first and second clutch pack 126, 128 are arranged axially in the direction of or along the axis of rotation A. Furthermore, the first and/or second clutch pack 126, 128 is/are in the form of a multi-disk clutch arrangement, preferably a wet-running multi-disk clutch arrangement.

The first and second clutch covers 106, 108 can be connectable for conjoint rotation or connected for conjoint rotation, in particular by fastening elements 132. The first and second clutch covers 106, 108 and the bearing carrier 130 can be connectable or connected to the fastening elements 132. For this purpose, the double clutch arrangement 30 can comprise one or more fastening elements 132. The first and second clutch cover 106, 108 can, in particular when they are connected to one another, form one or more cavities 134 and/or a clutch housing 136. The first and second clutch cover 106, 108 can be rotatable about the axis of rotation A. The first and/or second clutch pack 126, 128 can be arranged in the cavity or the cavities 134 and/or in the clutch housing 136. In addition, the first and/or the second clutch cover 106, 108 can have a sensor target 150, in particular an encapsulated sensor target, for determining the rotational speed during operation. The sensor target 150 can be arranged on the second clutch cover 108, preferably integrated therein.

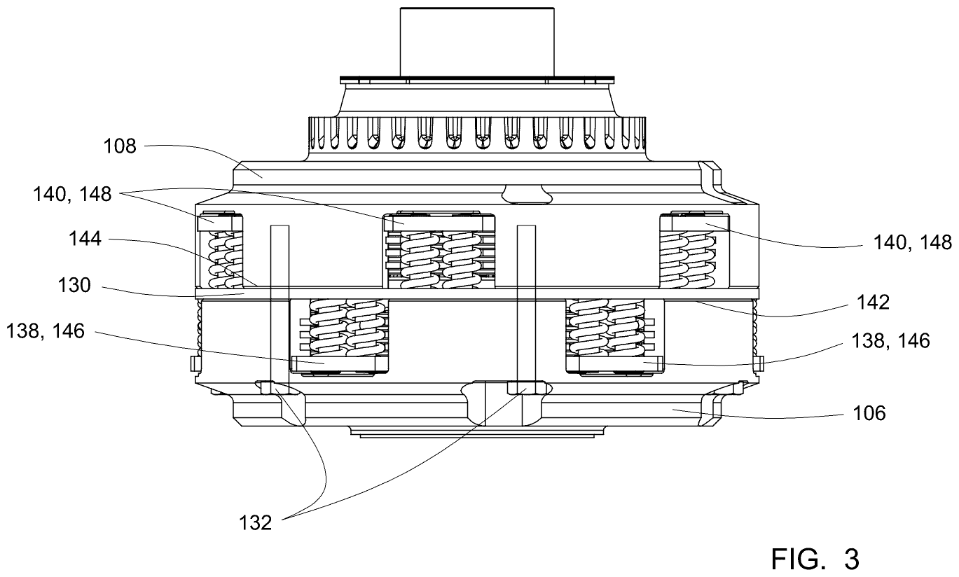

FIG. 3 shows another schematic illustration of the first example embodiment of the double clutch arrangement 30 according to the disclosure. The double clutch arrangement 30 shown in FIG. 3 substantially corresponds to the double clutch arrangement 30 shown in FIGS. 1 and 2, and therefore only details and/or points of differentiation will be discussed below. The work machine 10 illustrated in FIG. 1 or the drive train 20 can comprise the double clutch arrangement 30 illustrated in FIG. 3. A plurality of first bearing elements 138 are arranged between the first clutch cover 106 and the bearing carrier 130, and a plurality of second bearing elements 140 are arranged between the second clutch cover 108 and the bearing carrier 130.

The first bearing elements 138 are in each case distributed and/or arranged in the circumferential direction on a first side 142 of the bearing carrier 130, in particular on a side of the bearing carrier 130 facing the first clutch cover 106. The second bearing elements 140 are in each case distributed and/or arranged in the circumferential direction on a second side 144 of the bearing carrier 130, in particular on a side of the bearing carrier 130 facing the second clutch cover 108. The fastening elements 132 are in each case distributed and/or arranged in the circumferential direction on the first and second clutch cover 106, 108 and the bearing carrier 130. The first bearing elements 138 can be in the form of first springs or first spring pairs, and the second bearing elements 140 can be in the form of second springs or second spring pairs.

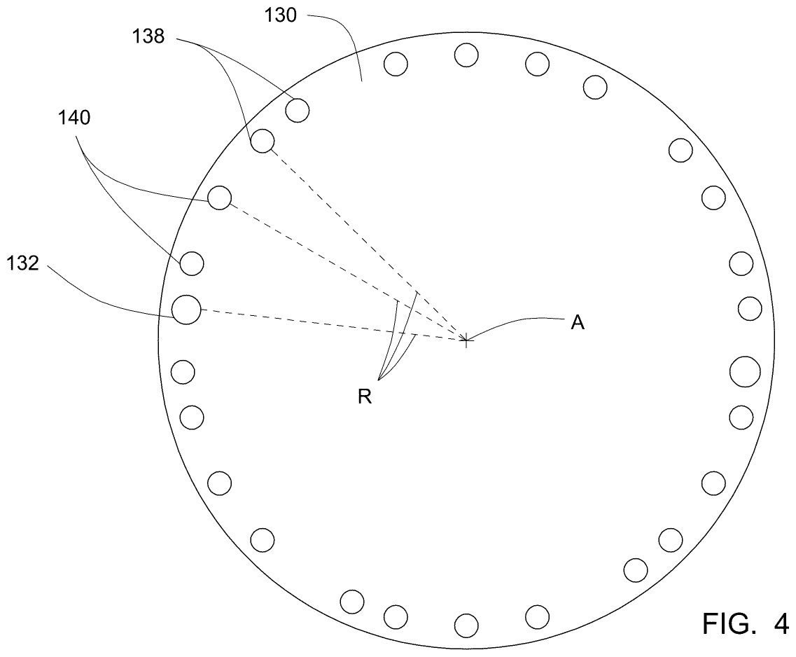

FIG. 4 shows another schematic illustration of the first example embodiment of the double clutch arrangement 30 according to the disclosure. The double clutch arrangement 30 shown in FIG. 4 substantially corresponds to the double clutch arrangement 30 shown in FIGS. 1 to 3, and therefore only details and/or points of differentiation will be discussed below. The work machine 10 illustrated in FIG. 1 or the drive train 20 can comprise the double clutch arrangement 30 illustrated in FIG. 4.

The first and second bearing elements 138, 140 and the fastening elements 132 are arranged on the bearing carrier 130 so as to be offset with respect to one another in the circumferential direction. In other words, the first and second bearing elements 138, 140 are not arranged centrally and/or symmetrically with respect to one another, but are arranged offset tangentially with respect to one another. The fastening elements 132 and/or the first and/or second bearing elements 138, 140 are arranged coaxially and/or concentrically with respect to the axis of rotation A. Moreover, the fastening elements 132 and/or the first and/or second bearing elements 138, 140 can be spaced apart and/or arranged with the same radius R with respect to the axis of rotation A.

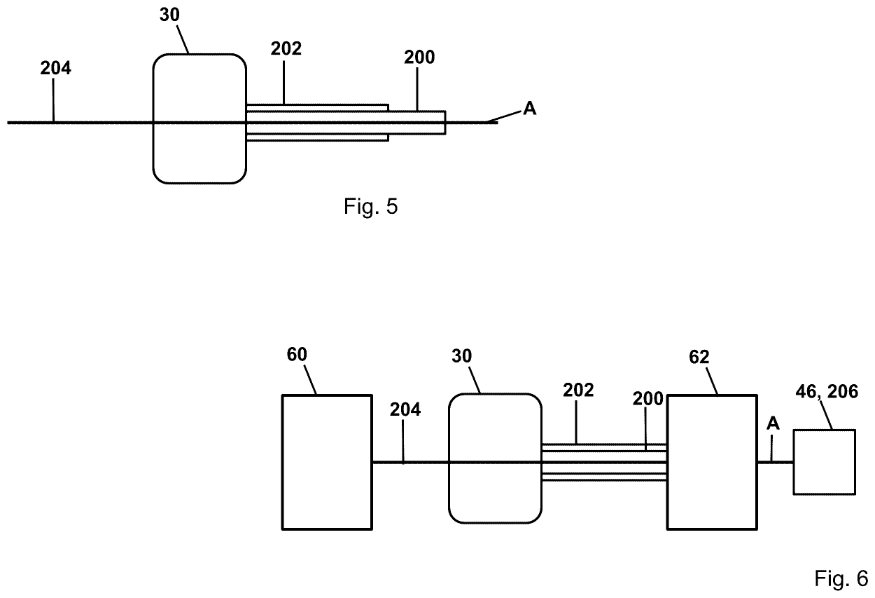

FIG. 5 shows a schematic illustration of a second example embodiment of the double clutch arrangement 30 according to the disclosure. The double clutch arrangement 30 shown in FIG. 5 substantially corresponds to the double clutch arrangement 30 shown in FIGS. 1 to 4, and therefore only details and/or points of differentiation will be discussed below. The work machine 10 illustrated in FIG. 1 or the drive train 20 can comprise the double clutch arrangement 30 illustrated in FIG. 5.

The double clutch arrangement 30, in particular the double clutch 100, comprises a first and a second driven shaft 200, 202. The first driven shaft 200 is connected to the first output side 102, in particular by splines. The second driven shaft 202 is connected to the second output side 104, in particular by splines. The double clutch arrangement moreover comprises an input shaft 204. The input shaft 204 can be connectable to the drive unit 60. The input shaft 204 is connected to the input side 118, in particular connected by splines. The first and second output side 102, 104 and the input side 118 each have a shaft feedthrough and/or a central passage for the input shaft 204. The input shaft 204 is embodied as a solid shaft. The first and second driven shaft 200, 202 are in the form of hollow shafts. The first driven shaft 200 is arranged in the second driven shaft 202, in particular freely rotatably arranged. The first and second driven shafts 200, 202 are arranged coaxially to each other. The input shaft 204 is arranged, in particular freely rotatably arranged, in the first driven shaft 200. Furthermore, the input shaft 204 is arranged, in particular freely rotatably arranged, in the input side 118 and in the first output side 102. The input shaft 204 and the first and second driven shafts 200, 202 are arranged coaxially to one another. The input shaft 204 extends through the first driven shaft 200.

FIG. 6 shows a schematic illustration of the drive train 20 according to the disclosure. The drive train 20 shown in FIG. 6 comprises the double clutch arrangement 30 shown in FIGS. 1 to 5, and therefore only details and/or points of differentiation will be discussed below. The work machine 10 illustrated in FIG. 1 can comprise the drive train 20 illustrated in FIG. 6.

The drive train comprises the drive unit 60 and the transmission 62. The drive unit 60 is connected to the first clutch cover 106 via or by the input shaft 204 and the input side 118.

The first and second output sides 102, 104 are, optionally, connectable or connected to the transmission 62, via or by the first and second driven shafts 200, 202. The transmission 62 can be a double clutch transmission, in particular with at least one winding path gear.

The input shaft 204 can at the same time be in the form of a power take-off drive shaft (PTO drive shaft) and can drive the first power output 46, preferably the PTO unit 206. In this way, a direct and therefore particularly energy-efficient transmission of the driving power from the drive unit 60 to the first power output 46 and/or to the PTO unit 206 is possible.

A force and/or a torque and/or a rotational speed can be transmissible from the drive unit 60 to the input side 118, in particular to the first clutch cover 106, via the or by the input shaft 204. A force and/or a torque and/or a rotational speed can be transmissible from the drive unit 60 to the first power output 46, in particular to the PTO unit 206, via the or by the input shaft 204.

A force and/or a torque and/or a rotational speed can be transmissible from the first output side 102 via or by the first driven shaft 200 to the transmission 62 and/or a force and/or a torque and/or a rotational speed can be transmissible from the second output side 104 via or by the second driven shaft 202 to the transmission 62.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A double clutch arrangement for arranging in a drive train of a work machine or in a work machine, comprising:
a first clutch cover rotatable about an axis of rotation of a first output side and a second output side, and
a second clutch cover rotatable about the axis of rotation of the first and second output sides,
wherein the first output side is mounted on the first clutch cover and the second output side is mounted on the second clutch cover.

2. The double clutch arrangement of claim 1, wherein the first output side is mounted on the first clutch cover with a first bearing and the second output side is mounted on the second clutch cover with a second bearing.

3. The double clutch arrangement of claim 1, further comprising a first clutch pack and a second clutch pack.

4. The double clutch arrangement of claim 3, wherein the first clutch pack is configured to connect the first clutch cover to the first output side when the first clutch pack is in engagement, or the second clutch pack is configured to connect the second clutch cover to the second output side when the second clutch pack is in engagement.

5. The double clutch arrangement of claim 1, wherein the first output side is arranged radially within the first and second clutch covers.

6. The double clutch arrangement of claim 1, wherein the first and second output sides are in the form of a hollow hub or in the form of a hollow shaft.

7. The double clutch arrangement of claim 4, wherein the first and second clutch packs are arranged axially.

8. The double clutch arrangement of claim 4, wherein at least one of the first or second clutch pack is in the form of a multi-disk clutch arrangement, including a wet-running or dry multi-disk clutch arrangement.

9. The double clutch arrangement of claim 1, further comprising a bearing carrier, wherein the bearing carrier is arranged between the first and second clutch covers, or the first and second clutch covers and the bearing carrier are connectable or connected to fastening elements, or a plurality of first bearing elements are arranged between the first clutch cover and the bearing carrier and a plurality of second bearing elements are arranged between the second clutch cover and the bearing carrier.

10. The double clutch arrangement of claim 9, wherein the first bearing elements are in each case distributed or arranged in the circumferential direction on a first side of the bearing carrier, the side of the bearing carrier facing the first clutch cover, or the second bearing elements are in each case distributed or arranged in the circumferential direction on a second side of the bearing carrier, the second side of the bearing carrier facing the second clutch cover, or the fastening elements are in each case distributed or arranged in the circumferential direction on the first and second clutch covers and the bearing carrier, or the first and second bearing elements are offset with respect to one another in the circumferential direction.

11. The double clutch arrangement of claim 9, wherein the first bearing elements are in the form of first springs or first spring pairs, and the second bearing elements are in the form of second springs or second spring pairs.

12. The double clutch arrangement of claim 9, wherein at least two of the fastening elements, the first bearing elements and second bearing elements are arranged coaxially or concentrically with respect to the axis of rotation or are spaced apart or arranged with the same radius with respect to the axis of rotation.

13. A drive train comprising:
double clutch arrangement for arranging in a drive train of a work machine or in a work machine, including:
a first clutch cover rotatable about an axis of rotation of a first output side and a second output side, and
a second clutch cover rotatable about the axis of rotation of the first and second output sides,
wherein the first output side is mounted on the first clutch cover and the second output side is mounted on the second clutch cover.

14. The drive train of claim 13, further comprising a drive unit and a transmission, wherein the drive unit is connectable or connected to the first clutch cover, or the first and second output sides is connectable or connected to the transmission.

15. A work machine comprising:
double clutch arrangement for arranging in a drive train of a work machine or in a work machine, including:
a first clutch cover rotatable about an axis of rotation of a first output side and a second output side, and
a second clutch cover rotatable about the axis of rotation of the first and second output sides,
wherein the first output side is mounted on the first clutch cover and the second output side is mounted on the second clutch cover.
